(19) United States
(12) Patent Application Publication
(10) Pub. No.: US 2023/0083912 A1
(43) Pub. Date: Mar. 16, 2023

(54) DEVICES, SYSTEMS, AND METHODS FOR DRYING LIQUID COATINGS ON PRODUCTS

(71) Applicant: Apeel Technology, Inc., Goleta, CA (US)

(72) Inventors: Daniel Ross, Goleta, CA (US); Thomas DuPar, Goleta, CA (US)

(21) Appl. No.: 17/939,674

(22) Filed: Sep. 7, 2022

Related U.S. Application Data
(60) Provisional application No. 63/243,376, filed on Sep. 13, 2021.

(51) Int. Cl. B05C 11/00; B05D 1/28; B05D 3/02; B05C 1/02

(52) U.S. Cl. CPC B05C 11/00; B05D 1/28; B05D 3/0227; B05D 3/0254; B05C 1/02

(57) ABSTRACT

Some embodiments of a coating system can include a conveyor and an infrared panel positioned above the conveyor, where the infrared panel outputs infrared energy toward the conveyor bed, a coating device positioned above a brush bed that dispenses coating material towards the brush bed, wherein the brush bed is configured to receive products; and a drying station comprising a rolling conveyor downstream from the brush bed.

### CROSS-REFERENCE TO RELATED APPLICATION

The application claims the benefit of priority to U.S. Provisional Patent Application No. 63/243,376, filed on Sep. 13, 2021, the entire contents of which are hereby incorporated by reference.

### TECHNICAL FIELD

This document describes devices, systems, and methods related to treatment of products, such as devices, systems, and methods for drying a liquid coating on perishable items.

### BACKGROUND

Products, such as food products, agricultural products, and fresh produce, are susceptible to degradation and decomposition (i.e., spoilage) when exposed to the environment. Product degradation can occur via abiotic means as a result of evaporative moisture loss from an external surface of the agricultural products to the atmosphere, oxidation by oxygen that diffuses into the agricultural products from the environment, mechanical damage to the surface, and/or light-induced degradation (i.e., photodegradation). Coatings dried on products can mitigate product degradation.

Many products are handled in packing houses, where they are sorted and packaged. While some of these processes (e.g., coating and drying) may be performed manually, industrial equipment, which either automates the processes or more easily facilitates carrying out the processes can be beneficial.

### SUMMARY

Promoting consistent and efficient drying of coatings on products (e.g., agricultural products) can improve coating performance and can facilitate downstream equipment cleanliness and functionality. Infrared drying elements (e.g., additionally or alternatively to the use of convective heat dryers and/or other drying components) can be beneficial to the efficient and consistent drying of coatings on products. For example, infrared drying elements can facilitate quickly elevating a product surface temperature to a level conducive to evaporation of a solvent (e.g., water) from a liquid coating composition, without over-heating or damaging the product.

Various embodiments described herein include one or more mechanisms that can improve the drying of a coating on a product. Some example treatment systems include an infrared panel to emit infrared energy toward the product. An example treatment system optionally treats agricultural products through a brushing system that applies a liquid coating to the product, and a conveyor system that moves the coated products to a heating apparatus that includes infrared panels.

In various example embodiments, parameters of the treatment system are controlled to achieve desired dryness or other coating characteristics. For example, the application and drying of a liquid coating solution may be controlled by the residence time within a drying system, the use of infrared panels in addition to or instead of convective and/or other drying techniques, air turbulence, temperature, humidity, and/or other parameters. In some embodiments, the liquid coating solution includes a relatively high water content (e.g., higher than some wax-based coatings). The treatment system parameters can be selected to promote efficient evaporation from the liquid coating material without over-heating or otherwise altering the product (e.g., appearance, taste, moisture content, etc.).

Some embodiments of the devices, systems, and techniques described herein may provide one or more of the following advantages. First, some embodiments described herein facilitate application and drying of a water-based coating solution to perishable items or other products. The water-based coating solution can be formulated to provide desired coating characteristics on the product to extend shelf life without substantially affecting the taste, appearance, moisture content, and tactile feel, for example. In some embodiments, an application system may be operated to provide a coating layer on product that reduces mass loss of the product (e.g., from moisture loss) over an extended period of time.

Second, some embodiments described herein facilitate contactless heating via infrared panels. Contactless heating can improve the efficiency of the drying process of a water-based coating by quickly imparting infrared energy to a product surface covered with a liquid coating while the product can move through the treatment system. Contactless heating can also promote sanitary operation. For example, contactless heating can decrease handling by human and/or mechanical means. Contactless heating can improve the consistency of a coating application and/or facilitate formation of a thicker coating (e.g., without the application of more liquid coating) by promoting efficient drying. In some embodiments, heating via infrared energy can quickly heat the surface of a product and facilitate quick evaporation of water in a water-based coating (e.g., without overheating or permanently altering the product).

Third, some embodiments described herein improves efficacy of the heating and cooling of products. For example, infrared energy applied to products can provide low-thermal inertia. For example, infrared energy rapidly heats the surface of a product without heating the interior of the product. In some embodiments, infrared energy can be applied to a product as a pre-treatment (e.g., prior to the application of a coating), post-treatment (e.g., after application of a coating), and/or at one or more other locations of a treatment system.

Fourth, some embodiments described herein facilitate the use of infrared energy to improve energy efficiency and reduce heat lost to the environmental surroundings. In some embodiments, radiant heat panels generate electromagnetic waves that are intercepted and absorbed by the product to generate heat. A high percentage of energy is absorbed to heat the surface of the product (e.g., relative to heating surrounding air). Alternatively or additionally, some example infrared heaters heat relatively quickly (e.g., almost instantly) when activated and stop heating quickly when deactivated, facilitating use of little time and energy to become operational, and/or while maintaining a controlled temperature of produce within the treatment system (e.g., in the event of a pause in advancement of the produce through the treatment system).

Fifth, some embodiments described herein facilitate precise application of heat to a product. In some embodiments, energy emitted from an infrared heating device can be focused, directed to the product, reflected and/or recovered. The infrared source can be controlled without significant impact from heated products in the surroundings, and/or can be quickly switched between activated and inactivated states.

Sixth, embodiments describing infrared energy can decrease the physical footprint of the machinery used in a drying apparatus. Infrared energy sources can direct energy to a target area while occupying relatively little space. In some embodiments, infrared energy sources facilitate quick elevation of product surfaces to a predetermined target temperature range in a short residence time/physical distance. The precision and quick heating of the product can be a cost saving measure implemented by manufacturers as products can move through a drying apparatus relatively quickly.

### BRIEF DESCRIPTION OF THE DRAWINGS

FIG. 1A is a schematic of an example coating system.

FIG. 1B is a schematic of an example coating system including infrared energy application prior to treatment with a coating material.

FIG. 1C is a schematic of an example coating system including infrared energy application after treatment with a coating material.

FIG. 1D is a schematic of an example coating system including infrared energy application and convective heat application after treatment with a coating material.

FIG. 1E is a schematic of an example coating system including infrared energy application after treatment with a coating material.

FIG. 2 depicts % water mass remaining a 1200° F. infrared panel, with a 4 inch offset.

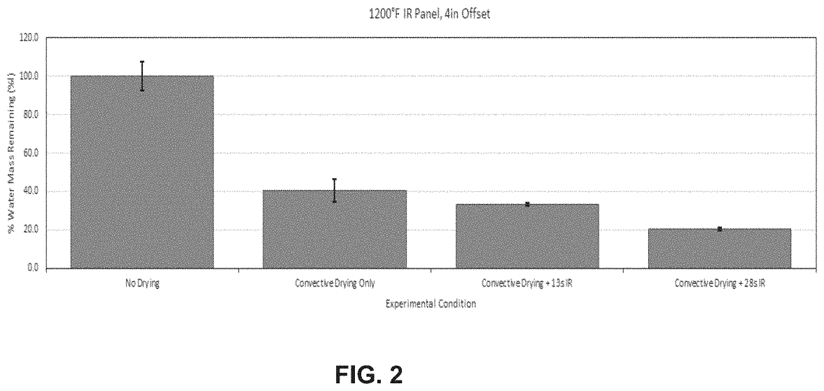

FIG. 3 depicts % water mass remaining (% I) with different experimental drying conditions.

FIG. 4 depicts water mass per avocado (ml) over time in different experimental conditions.

FIG. 5 depicts the mass loss factor of the avocados tested in Example 2.

FIG. 6 depicts measured residence time for complete dryness relative to full convection.

FIG. 7 depicts energy consumption during required residence time for complete dryness relative to full convection.

FIG. 8 depicts the mass loss factor of Hybrid and Full Infrared system compared with Heated Convection Drying alone.

FIG. 9 depicts CO₂ production rate (ml/kg hr.) and ripening time of Hybrid and Full Infrared system compared with Heated Convection Drying alone.

FIG. 10 depicts the incidence of skin burns to the avocados of Hybrid and Full Infrared system compared with Heated Convection Drying alone.

FIG. 11 depicts the internal quality of avocados of Hybrid and Full Infrared system compared with Heated Convection Drying alone.

### DETAILED DESCRIPTION OF ILLUSTRATIVE EMBODIMENTS

The term “mass loss rate” refers to the rate at which the product loses mass (e.g. by releasing water and other volatile compounds). In an example embodiment, the mass loss rate is expressed as a percentage of the original mass per unit time (e.g. percent per day).

The term “mass loss factor” refers to the ratio of the average mass loss rate of uncoated plant matter (measured for a control group) to the average mass loss rate of the corresponding tested plant matter (e.g., coated plant matter) over a given time. Hence a larger mass loss factor for a coated plant matter corresponds to a greater reduction in average mass loss rate for the coated plant matter.

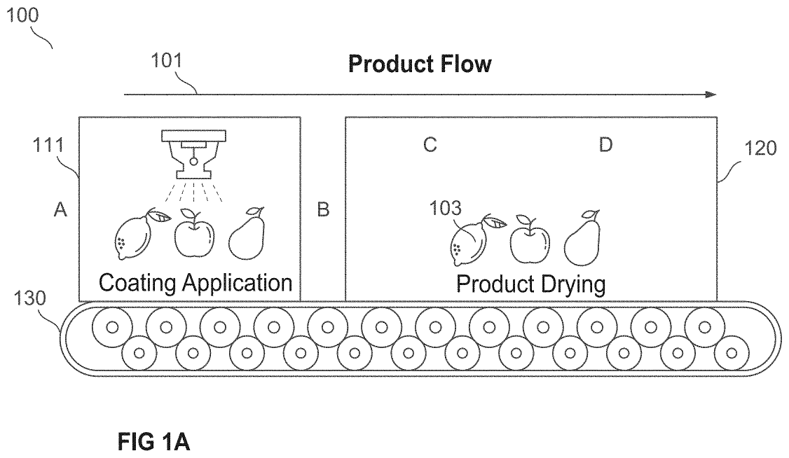

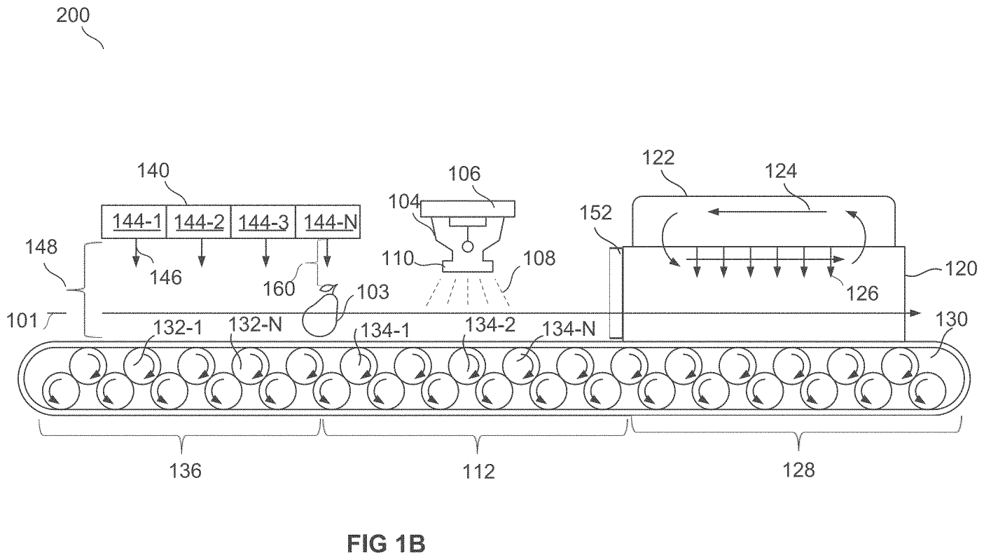

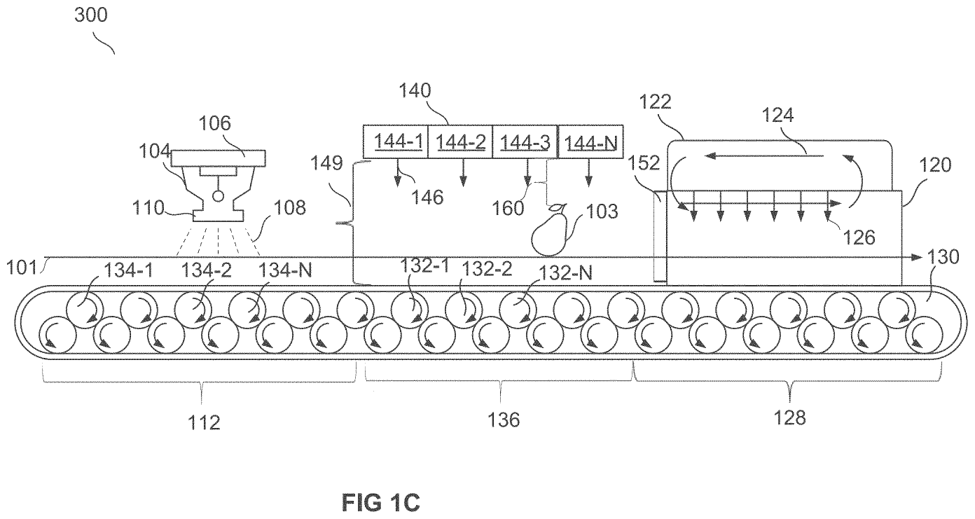

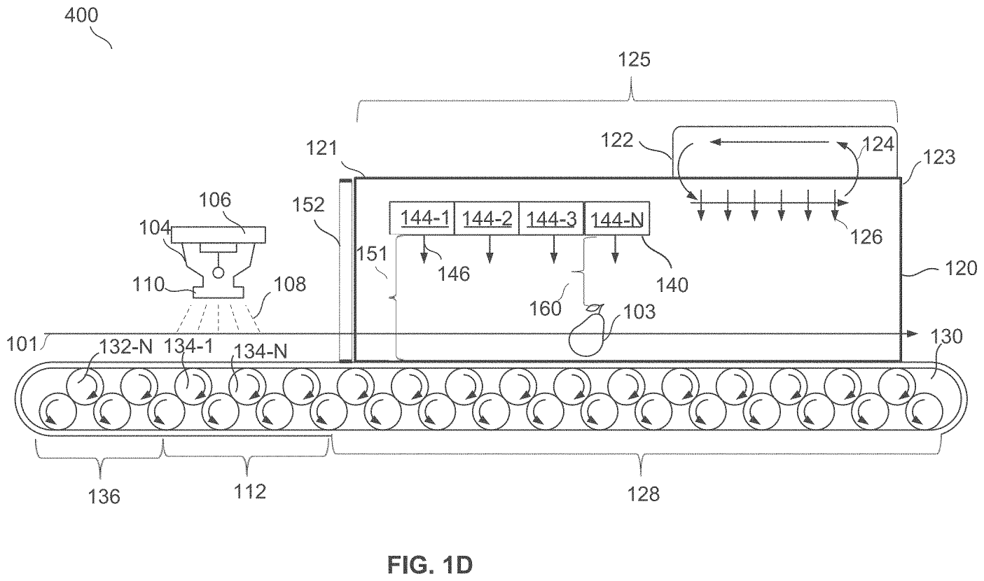

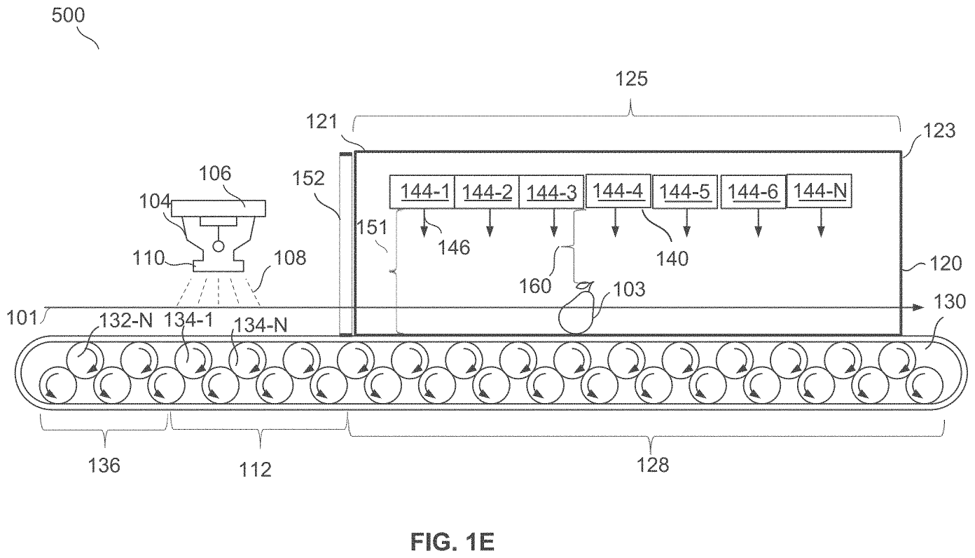

FIG. 1A is a schematic of example coating system 100. Coating system 100 includes, coating application station 111, product drying station 120, and conveyor 130. Products move through the coating system 100 in the direction of product flow 101. The letters “A”, “B”, “C”, and “D” represent example locations in the product flow 101 where infrared energy is optionally applied to the product. The coating system 100 treats products (e.g. received from a remote harvest location, packing houses, transport vehicles, etc.) with a protective liquid coating by submersion in a liquid coating material, spray application, and/or brush application. The infrared energy raises a surface temperature of products moving through coating system 100 to facilitate drying of the liquid coating applied to the products (e.g., via evaporative mechanisms), without over-heating or otherwise perceptibly altering a taste, appearance, moisture content, tactile feel, etc. of the produce.

The coating system 100 is configured to treat (e.g., coat) products 103 such as apples, citrus, berries, melons, apricots, asparagus, avocados, bananas, blueberries, bayberries, cherries, clementine, mandarins, cucumbers, custard apples, figs, grapes, grapefruit, guava, kiwifruit, limes, lychees, mamey sapotes, mangos, melons, papaya, nectarines, oranges, peaches, pears, persimmon, pineapples, plums, strawberries, tomatoes, watermelon, peppers, leafy produce, fruits, vegetables, legumes, nuts, flowers, processed food items, candy, vitamins, nutritional supplements, and the like, and/or combinations thereof. Alternatively or additionally, the coating system 100 treats non-agricultural products, including paper products, packaging, rigid crates, etc.

The coating system 100 includes a product travel path (indicated by the product flow 101) that products and/or product containers move along through the coating system 100 as indicated by product flow 101. Conveyor 130 can transport products to the coating application station 111. After the product 103 has been coated, conveyor 130 can transport the coated product 103 to product drying station 120. The products enter product drying station 120 (e.g., via conveyor 130 from coating application station 111). In an example embodiment, the product flow 101 is arranged linearly, such that products advance into coating station 111 and drying station 120.

Product drying station 120 includes one or more drying operations (e.g., an infrared heater and/or a drying apparatus) that facilitate formation of a dried coating on the product surface. In an example embodiment, product drying station 120 includes an infrared panel and a convective air-drying tunnel. The infrared panel imparts infrared energy to a surface of the product (e.g., to elevate a surface temperature of the product). The convective air-drying tunnel facilitates convective drying mechanisms. For example, the air-drying tunnel of product drying station 120 includes circulating gas (e.g., circulating air). Products advanced through drying station 120 pass along a drying path in which a blower pushes hot air into the system, and/or fans along the length provide airflow over the product surface. Alternatively or additionally, the drying operation uses a pressure buildup via a perforated plate to supply high velocity air across the product path. In some embodiments, temperature set points for the drying operation are between 110-205° F., 120-195° F., 130-170° F., or 145-176° F. (e.g., a measured temperature of heated air delivered into the drying tunnel). The drying operation includes, in some embodiments, air recirculation, and optionally humidity control systems with the addition of a ventilation duct and modulating exhaust.

Infrared energy is applied to the product 103 at one or more locations within the coating system 100. In an example embodiment, infrared energy is applied to the product 103 prior to the coating application station 111 (e.g., at location “A”). Application of infrared energy at location “A” can elevate a surface temperature of the product 103 before the product receives the liquid coating material on its surface. The application of infrared energy applied to the product 103 prior to the coating application station 111 is described in greater detail in connection with FIG. 1B.

Alternatively or additionally, infrared energy is applied to the product 103 after the coating application station 111 (e.g., at location “B”). For example, the infrared energy is applied to the product 103 after the product 103 has been treated with a protective coating and prior to the product 103 encountering other drying mechanisms at product drying station 120 (e.g., convective drying). Application of infrared energy at location “B” can quickly elevate a temperature of the liquid coating material and/or the surface of product 103 to a predetermined temperature that facilitates evaporation of a liquid component of the liquid coating material. The application of infrared energy applied to the product 103 after to the coating application station 111 is described in greater detail in connection with FIG. 1C.

In some embodiments, infrared energy is applied to the product 103 after the coating application station 111 (at location “C”). For example, the infrared energy is applied while the product passes through product drying station 120 (e.g., within a drying tunnel). The infrared energy is emitted within a drying apparatus (e.g., that also includes one or more other drying operations, such as convective heat, ambient temperature air-flow, etc.). Application of infrared energy at location “C” can quickly elevate a temperature of the liquid coating material and/or the surface of product 103 to a predetermined temperature that facilitates evaporation of a liquid component of the liquid coating material, and in some embodiments can enhance the effectiveness of convective drying mechanisms. The application of infrared energy applied to the product 103 after the coating application station 111 and in addition to one or more other drying operations is described in greater detail in connection with FIG. 1D.

In some embodiments, the infrared energy is applied to the product 103 after the coating application station 111 (at location “D”). The infrared energy is a part of product drying station 120. For example, indicated by letter “D”, the infrared energy is included within a drying apparatus. In some embodiments, the infrared energy is the only energy source (e.g., aside from the ambient environment) directed to the product 103, such that the infrared energy is not applied in conjunction with another drying operation. The application of infrared energy applied to the product 103 after to the coating application station 111 and without other drying operations is described in greater detail in connection with FIG. 1E.

In various example embodiments, subjecting the product 103 to infrared energy can enhance the efficacy and efficiency of product drying (e.g., by quickly elevating a surface of the product 103 to a predetermined temperature that facilitates evaporative drying). Alternatively or additionally, infrared energy can improve the performance of the dried coating on the product 103. For example, product exposed to infrared energy as part of a treatment system can have a higher average mass loss factor than products that were dried in ambient conditions. In some embodiments, infrared drying facilitates a desired coating thickness and/or coating thickness consistency that enhances coating effectiveness in reducing mass loss.

Referring now to FIG. 1B, a schematic of an example coating system 200 is shown having infrared energy application prior to treatment of a product 103 with a coating material. The coating system 200 includes an infrared heater 140 having one or more infrared panels 144-1, 144-2, 144-3, 144-N. The infrared heater 140 outputs infrared energy 146 toward a conveyor 130 and/or product 103. In an example embodiment, infrared energy 146 rapidly heats the surface of a product 103 such that when the coating material 108 is subsequently applied to the product 103, the surface of the product 103 is at an elevated temperature (e.g., relative to a product surface temperature prior to application of the infrared energy). The elevated surface temperature of the product 103 can facilitate the evaporation of liquid components (e.g., water) of coating material 108.

Conveyor 130 includes conveyor bed 136 having a plurality of translational rotational cylinders 132-1, 132-N (collectively referred to herein as translational rotational cylinders 132). Alternatively or additionally, the conveyor 130 is composed of multiple sequential conveyors arranged to coordinate the transport of product 103 through the coating system 200. The translational rotational cylinders 132 move a product 103 in the direction of the product flow 101. In some embodiments, the translational rotational cylinders 132 facilitate movement of one or more products from the conveyor bed 136 to the brush bed 112 positioned below the coating device 104.

The coating system 200 includes coating device 104. The coating device 104 includes a reservoir 106 which contains and/or dispenses coating material 108. The coating device 104 is positioned above a brush bed 112. The brush bed 112 includes a plurality of rotational brushes 134-1, 134-2, 134-N (which may be collectively referred to herein as rotational brushes 134). In some embodiments, the plurality of rotational brushes 134 can facilitate the application of a liquid (e.g., coating material 108) to one or more products. In some embodiments, the rotational brushes 134 comprise bristles.

The reservoir 106 contains the coating material 108 to be dispensed to product 103 surfaces. For example, while the product 103 moves along conveyor 130 (e.g. laterally along product flow 101), the coating device can spray or otherwise distribute droplets of a coating material 108 (e.g., a solution, suspension, emulsion, etc.) over the surface of the product. The coated product 103 then optionally passes beneath blower exhausts that facilitate controlled removal (e.g., via evaporation) of the solvent while the product 103 is on the conveyor 130 (and/or the brush bed 112). Evaporation of the solvent results in a dried protective coating on the surface of the product 103. In some implementations, a single coating of the coating material 108 is applied to the product. Alternatively or additionally, multiple coatings (e.g., of the same or different coating material) may be applied. In some embodiments, the coating system 200 includes a spray apparatus 110 coupled to the coating device 104 and configured to dispense the coating material 108.

The coating system 200 includes a drying station 120 having a drying apparatus 122. In various example embodiments, the drying station 120 includes a drying tunnel (e.g., having one or more features of the drying tunnel described above with reference to FIG. 1A). The drying apparatus 122 includes circulating gas 124 (e.g., circulating air). In some embodiments, the drying apparatus 122 can be in the shape of a tunnel such that products move through the tunnel along the product path 101. The drying apparatus 122 includes a heating element that facilitates convective heat 126 toward a rolling conveyor 128. In some embodiments, the drying apparatus 122 includes one or more shields 152. The one or more shields 152 can insulate the heat generated by the heating element of the drying apparatus 122 from the area outside of the drying station 120. The shields 152 can facilitate energy efficiency by maintaining heat energy within the drying apparatus 122, and/or facilitate precise application of heat by preventing application of heat to the product 103 before entering the drying station 120.

In some embodiments, the coating system 200 can include a drying tunnel having various components for circulating conditioned air to dry products that are transported by the conveyor 130. For example, the drying tunnel includes an intake blower configured to draw air into the drying tunnel, and an exhaust blower configured to discharge air from the drying tunnel. In some embodiments, a heating element is coupled to the drying apparatus 122 and is configured to heat gas to a temperature above ambient temperature. One or more hot air recirculation control dampers can control volume of recirculated air and/or facilitate control of one or more air temperature and humidity values. The coating system 200 includes one or more airflow control panels that are disposed at different locations in the drying station 120 and/or the drying apparatus 122 and configured to control airflow at such locations. The drying station 120 includes one or more fan assemblies that are disposed at different locations in the drying station 120 or drying apparatus 122 and configured to drive air flow at desired directions.

In some embodiments, the products move (e.g., linearly) in the direction indicated by the product flow 101, and/or undergo multi-axis rotational motion (e.g., tumbling, rolling, etc.) via the translational rotational cylinders 132, the rotational brushes 134, and/or the conveyor bed 136. For example, the brush bed 112 of FIG. 1B imparts a tumbling motion in a transported product 103 corresponding to the product 103 contact with rotational brushes 134 undergoing rotational motion. Product 103 tumbling can facilitate exposure of large portions of the product 103 surface to the coating material 108, promoting consistent coverage of the entire product 103 surface, facilitating consistent and complete coverage of the product 103 surface. In some embodiments, a vibratory mechanism that induces vibrations on the conveyor 130 or tumbling in the product 103 can alternatively, or additionally, impart tumbling motion. In some embodiments, the plurality of rotational brushes 134 can facilitate the application of a liquid (e.g., coating material 108) to one or more products.

The infrared heater 140 includes a plurality of infrared panels 144 which produce infrared energy 146 based on various temperature outputs of the infrared heater 140. For example, the infrared heater 140 (e.g., the infrared panel(s) 144) includes heating elements that, when heated to a temperature, causes the element to radiate infrared energy 146 which is absorbed by the product 103. A radiating element from the infrared panel(s) 144 is the result of a temperature of the element in the infrared panel(s) 144. In some embodiments, the radiating element(s) in the infrared panel(s) 144 is in a range between 300° F. and 1600° F. In some embodiments, the radiating elements of the infrared panel 144 is 700° F. to 900° F., 900° F. to 1100° F., 1100° F. to 1300° F., 1300° F. to 1500° F. In some embodiments, the radiating element of the infrared panel is 700° F. to 900° F. In some embodiments, the radiating element of the infrared panel is 900° F. to 1100° F. In some embodiments, the radiating element of the infrared panel is 1100° F. to 1300° F. In some embodiments, the radiating element of the infrared panel is 1300° F. to 1500° F. These ranges can quickly heat the surface of a product 103 without damaging the internal portions of the product 103.

The infrared panels 144 are located a distance 148 above the conveyor bed 136. During operation, products can be positioned on the translational rotational cylinders 132 under the infrared panels 144 prior to the application of the coating material 108 and entering the drying station 120. The distance 148 illustrates the distance between the conveyor 130 (e.g., conveyor bed 136) and the infrared panels 144; and the distance 160 between the product 103 and the infrared panels 144 can be controlled to affect energy transfer from the infrared panels 144 to the products 103.

In an example embodiment, infrared panel 144 is arranged a fixed distance 148 from a conveyor 130. For example, the infrared panel 144 is arranged such that a distance 148, separates the energy-emitting surface of infrared panel 144 from the conveyor 130.

In some embodiments, the infrared panel 144 is movable to adjust distance 148. For example, distance 148 can be altered according to product size, product volume, desired distance 160 between the infrared panel 144 and the product 103, and/or desired power density. The distance 148 is adjusted by moving the infrared panel 144 and/or a position of conveyor 130. In an example embodiment, the movement of the infrared panel 144 is performed manually, e.g., by an operator. Alternatively or additionally, infrared panel 144 may be automatically movable by the coating system 200 in response to a condition or command, such as to obtain or maintain a predetermined distance between conveyor 130 and/or product 103. The distances 148, 160 can be selected at least partially based on the operational power of the infrared panels 144, product type, product size, transport time under the infrared panels 144 (e.g., residence time). For example, maintaining a consistent distance from the product surface can promote treatment consistency.

In some embodiments, the distance 148 between the conveyor bed 136 and the infrared panels 144 and/or a minimum distance 160 between the product 103 and the infrared panel 144 is in a range between 1 inch and 40 inches, 5 inches to 40 inches, 10 inches to 30 inches, 15 inches to 30 inches, 20 inches to 30 inches, or about 25 inches to 30 inches. In some embodiments, the distance 148 between the conveyor bed 136 and the infrared panels, and/or a minimum distance 160 between the product 103 and the infrared panels 144 is 1 inch to 20 inches. In some example embodiments, such values can efficiently elevate a surface temperature of the product 103 to facilitate drying of the coating material 108 without damaging or permanently altering the product 103 (e.g., permanently altering the appearance, taste, moisture content, etc.). In some embodiments, a larger distance 148 or 160 can provide for increased residence time before reaching a predetermined temperature threshold for a given infrared panel 144 temperature. In some embodiments, a relatively smaller distance 148 or 160 can decrease residence time and/or more quickly increase the surface temperature of the product 103 for a given infrared panel 144 temperature.

The residence time of a product subjected to infrared energy from infrared panel 144 can be controlled to impart a predetermined energy dosage or to elevate a surface of the product 103 to a predetermined temperature. In an example embodiment, the treatment intensity (e.g., the intensity of the infrared heater 140), the distance 148 or 160, transportation speed of the conveyor 130, product 103 movement speeds, and product 103 surface area can be controlled to affect the residence time. In some example embodiments, a greater distance 148 or 160 corresponds to a decreased infrared energy 146 output imparted to the product 103 and/or a higher residence time may be used to elevate the surface temperature of the product 103 to the predetermined temperature. In some example embodiments, a smaller distance 148 or 160 can correspond to an increased infrared energy 146 output imparted to the product 103 and a decreased residence time may be used to elevate the surface temperature of the product 103 to the predetermined temperature. In some embodiments, a length of time that the product 103 is between the conveyor bed 136 and the infrared panels 144 is 1 second to 200 seconds. In some embodiments, the length of time is 50 seconds, 75 seconds, 100 seconds, 150 seconds, or 200 seconds. In some embodiments, a reduced residence time and/or a residence time in parallel with one or more other operations of coating system 200 can promote a relatively short overall treatment time. Alternatively or additionally, a reduced residence time and/or a residence time in parallel with one or more other operations of coating system 200 can promote a relatively small physical footprint of coating system 200.

In some embodiments, the initial temperature of the product (e.g., before being treated by the treatment system) is between 25° F. and 75° F., between 30° F. and 50° F., or between above 32° F. and 40° F.

The infrared heater (e.g., infrared heater 140) outputs infrared energy (e.g., infrared energy 146) based on various element temperatures of the infrared heater 140. The infrared heater 140 (e.g., the infrared panel(s) 144) includes heating elements that, when heated to a temperature, causes the element to radiate infrared energy 146 which is absorbed by the product 103, thereby heating the product 103. A radiating output from the infrared panel(s) 144 is the result of a temperature of the element in the infrared panel(s) 144. In some embodiments, a first elevated temperature of the elements in the infrared panel(s) 144 is 500° F. to 1600° F. In some embodiments, the radiating elements of the infrared panel(s) is 700° F. to 900° F., 900° F. to 1100° F., 1100° F. to 1300° F., 1300° F. to 1500° F. In some embodiments, the first elevated element(s) temperature is 700° F., 800° F., 900° F., 1000° F., 1100° F., 1200° F., 1300° F., 1400° F., 1500° F., or 1600° F.

In some embodiments, the products 103 are subjected to a second elevated temperature via convection heat from a drying apparatus (e.g., drying apparatus 122). In some embodiments, the drying apparatus includes circulating gas (e.g., circulating gas 124). In some embodiments, the second elevated temperature within the drying apparatus is 125° F. to 175° F. In some embodiments, the second elevated temperature is 135° F. to 175° F., 145° F. to 175° F., 155° F. to 175° F., or 165° F. to 175° F.

In some embodiments, a length of time that the product is exposed to the convective heat and/or the infrared energy is 1 second to 200 seconds. In some embodiments, the length of time is 50 seconds, 75 seconds, 100 seconds, 150 seconds, or 200 seconds.

In some embodiments, an amount or dosage of energy imparted to the product 103 can be determined based on one or more parameters, such as infrared output temperatures, lengths of time (e.g., residence time), and/or distance between the conveyor and the infrared panels. For example, distance and temperature can affect the residence time sufficient for drying of a coating material on a surface of a product. In some examples, the distance between an infrared panel and the product and/or conveyor may be large which can decrease the infrared energy that is imparted to the product in a given length of time. In some embodiments, a relatively lower infrared intensity and a relatively longer residence time may facilitate treatment of products that may be sensitive to temperature and/or larger products that may require more time to expose their surface sufficiently to facilitate even heating. In some embodiments, the distance between an infrared panel and the product and/or conveyor may be small which can increase the infrared energy that is imparted to the product in a given length of time. A relatively higher infrared intensity and a relatively shorter residence time may facilitate treatment of products that may benefit from moving through the drying process quickly and/or smaller products that may require less time to expose their surface sufficiently to facilitate even heating.

Referring now to FIG. 1C, a schematic of an example coating system 300 is shown having infrared energy application after treatment of a product 103 with a coating material. In an example embodiment, coating system 300 includes one or more features of example coating system 200 described above with reference to FIG. 1B. The coating system 300 includes an infrared heater 140 having a plurality of infrared panels 144. The infrared heater 140 outputs infrared energy 146 toward a conveyor 130 and/or product 103. In an example embodiment, infrared energy 146 rapidly heats liquid coating on the surface of a product 103 and/or the surface of the product 103. The infrared energy heats the liquid and or surface of product 103 to facilitate the evaporation of liquid components (e.g., water) of coating material 108. In some embodiments, the infrared energy facilitates rapid initiation of evaporation of water from the coating material 108, reducing dripping or bulk removal of liquid coating material. A thicker coating layer and/or more consistent coating layer can be promoted.

Conveyor 130 includes conveyor bed 136 which includes a plurality of translational rotational cylinders 132-N. Alternatively or additionally, the conveyor 130 is composed of multiple sequential conveyors arranged to coordinate the transport of product 103 through the coating system 300. The translational rotational cylinders 132 move a product 103 in the direction of the product flow 101. In some embodiments, the translational rotational cylinders 132 facilitate movement of one or more products from the brush bed 112 positioned below the coating device 104 to the drying apparatus 122 within the drying station 120.

The coating system 300 includes coating device 104. The coating device 104 includes a reservoir 106 which contains and/or dispenses coating material 108 (e.g., via spray apparatus 110). The coating device 104 is positioned above a brush bed 112. The brush bed 112 includes a plurality of rotational brushes 134-1, 134-2, 134-N. In some embodiments, the rotational brushes 134 comprise bristles that facilitate the application of a liquid (e.g., coating material 108) to one or more products.

The coating system 300 includes a drying station 120 further comprising a drying apparatus 122. The drying apparatus 122 includes circulating gas 124 (e.g., circulating air). In some embodiments, the drying station 120 and/or the drying apparatus 122 can be in the shape of a tunnel such that products move through the tunnel along the product path 101. The drying apparatus 122 includes a heating element that facilitates convective heat 126 toward a rolling conveyor 128. In some embodiments, the drying apparatus 122 includes one or more shields 152. The one or more shields 152 can insulate the heat generated by the heating element of the drying apparatus 122 from the area outside of the drying station 120. The shields 152 can facilitate energy efficiency by maintaining heat energy within the drying apparatus 122, and/or facilitate precise application of heat by preventing application of heat to the product 103 before entering the drying station 120.

In some embodiments, the coating system 300 includes a drying tunnel having various components for circulating conditioned air to dry products that are transported by the conveyor 130. For example, the drying tunnel includes an intake blower configured to draw air into the drying tunnel, and an exhaust blower configured to discharge air from the drying tunnel. In some embodiments, a heating element is coupled to the drying apparatus 122 and is configured to heat gas to a temperature above ambient temperature. One or more hot air recirculation control dampers can control volume of recirculated air and/or facilitate control of one or more air temperature and humidity values. The coating system 300 includes one or more airflow control panels that are disposed at different locations in the drying station 120 and/or the drying apparatus 122 and configured to control airflow at such locations. The drying apparatus 122 includes one or more fan assemblies that are disposed at different locations in the drying station 120 and/or drying apparatus 122 and configured to drive airflow at desired directions.

The system 300 includes one or more infrared panels 144 located a distance 149 above the conveyor bed 136. During operation, products are placed on the plurality of rotational brushes 134-1, 134-2, 134-N that facilitate the application of liquid (e.g., coating material 108) to one or more products. The plurality of rotational brushes 134-1, 134-2, 134-N move the product to the translational rotational cylinders 132-1, 132-2, 132-N under the infrared panels 144 after the application of the coating material 108 (e.g., prior to entering the drying apparatus 122). The distance 149 between the conveyor 130 (e.g., conveyor bed 136) or the distance 160 between the product 103 and the infrared panels 144 can be controlled to affect energy transfer from the infrared panels 144 to the products 103.

In an example embodiment, infrared panel 144 is arranged a fixed distance 149 from a conveyor 130. For example, the infrared panel 144 is arranged such that a distance 149, separates the energy-emitting surface of infrared panel 144 from the conveyor 130.

In some embodiments, the infrared panel 144 is movable to adjust distance 149. For example, distance 149 can be altered according to product size, product volume, desired distance 160 between the infrared panel 144 and the product 103, and/or desired power density. The distance 149 is adjusted by moving the infrared panel 144 and/or a position of conveyor 130. In an example embodiment, the movement of the infrared panel 144 is performed manually, e.g., by an operator. Alternatively or additionally, infrared panel 144 may be automatically movable by the coating system 300 in response to a condition or command, such as to obtain or maintain a predetermined distance between conveyor 130 and/or product 103. The distances 149, 160 can be selected at least partially based on the operational power of the infrared panels 144, product type, product size, transport time under the infrared panels 144 (e.g., residence time). For example, maintaining a consistent distance from the product surface can promote treatment consistency.

In some embodiments, the distance 149 between the conveyor bed 136 and the infrared panels 144 and/or a minimum distance 160 between the product 103 and the infrared panel 144 is in a range between 1 inch and 40 inches, 5 inches to 40 inches, 10 inches to 30 inches, 15 inches to 30 inches, 20 inches to 30 inches, or about 25 inches to 30 inches. In some embodiments, the distance 149 between the conveyor bed 136 and the infrared panels, and/or a minimum distance 160 between the product 103 and the infrared panels 144 is 1 inch to 20 inches. In some example embodiments, such values can efficiently elevate a surface temperature of the product 103 to facilitate drying of the coating material 108 without damaging or permanently altering the product 103 (e.g., permanently altering the appearance, taste, moisture content, etc.). In some embodiments, a larger distance 149 or 160 can provide for increased residence time before reaching a predetermined temperature threshold for a given infrared panel 144 temperature. In some embodiments, a relatively smaller distance 149 or 160 can decrease residence time and/or more quickly increase the surface temperature of the product 103 for a given infrared panel 144 temperature.

The residence time of a product subjected to infrared energy from infrared panel 144 can be controlled to impart a predetermined energy dosage or to elevate a surface of the product 103 to a predetermined temperature. In an example embodiment, the treatment intensity (e.g., the intensity of the infrared heater 140), the distance 149 or 160, transportation speed of the conveyor 130, product 103 movement speeds, and product 103 surface area can be controlled to affect the residence time. In some example embodiments, a greater distance 149 or 160 corresponds to a decreased infrared energy 146 output imparted to the product 103 and/or a higher residence time may be used to elevate the surface temperature of the product 103 to the predetermined temperature. In some example embodiments, a smaller distance 149 or 160 can correspond to an increased infrared energy 146 output imparted to the product 103 and a decreased residence time may be used to elevate the surface temperature of the product 103 to the predetermined temperature. In some embodiments, a length of time that the product 103 is between the conveyor bed 136 and the infrared panels 144 is 1 second to 200 seconds. In some embodiments, the length of time is 50 seconds, 75 seconds, 100 seconds, 150 seconds, or 200 seconds. In some embodiments, a reduced residence time and/or a residence time in parallel with one or more other operations of coating system 300 can promote a relatively short overall treatment time. Alternatively or additionally, a reduced residence time and/or a residence time in parallel with one or more other operations of coating system 300 can promote a relatively small physical footprint of coating system 300.

Referring now to FIG. 1D, a schematic of an example coating system 400 is shown having infrared energy application and convective heat application after treatment with a coating material. In an example embodiment, coating system 400 includes one or more features of example coating systems 200 and/or 300 described above with reference to FIGS. 1B and 1C. The coating system 400 includes an infrared heater 140 having a plurality of infrared panels 144. The infrared heater 140 outputs infrared energy 146 toward rolling conveyor 128 and/or product 103. Convective heat 126 and infrared energy 146 are imparted onto the product 103 at least partially simultaneously. The infrared heater 140 and circulating gas 124 and convective heat 126 subject the product 103 to infrared and convective heating within the drying apparatus 122. In an example embodiment, drying station 120 facilitates efficient drying by quickly elevating a surface of product 103 to a temperature that facilitates evaporative drying of the liquid coating material, and which is in turn enhanced by convective heat within the drying apparatus 122. Alternatively or additionally, the use of infrared heater 140 in conjunction with convective heat 126 (e.g., simultaneously) can enhance drying efficacy in a relatively small footprint and/or with a relatively short residence time within the drying station 120.

The drying station 120 includes a first end 121 and a second end 123 having a first distance 125 between the first and second ends 121, 123. In some embodiments, the infrared panel 144 extends the first distance 125 of the drying station 120 from the first end 121 to the second end 123 of the drying station 120. In some embodiments, the infrared panel 144 extends less than the entire distance 125 of the drying station 120, such as one third of the first distance 125 of the drying station 120. In some embodiments, the infrared panel 144 extends half of the first distance 125 of the drying station 120. In some embodiments, the infrared panel 144 extends the drying station 120 two thirds of the first distance 125 of the drying apparatus 122. In various example embodiments, the infrared panel 144 extends 5% to 90%, 10% to 90%, 20% to 80%, 25% to 75%, 30% to 60%, or about 33% of the first distance 125.

Conveyor 130 includes conveyor bed 136 which includes a plurality of translational rotational cylinders 132-N. Alternatively or additionally, the conveyor 130 is composed of multiple sequential conveyors arranged to coordinate the transport of product 103 through the coating system 400. The translational rotational cylinders 132 move a product 103 in the direction of the product flow 101. In some embodiments, the translational rotational cylinders 132 facilitate movement of one or more products from the conveyor bed 136 to the brush bed 112 positioned below the coating device 104.

The coating system 400 includes coating device 104. The coating device 104 includes a reservoir 106 which contains and/or dispenses coating material 108 via spray apparatus 110. The coating device 104 can be positioned above a brush bed 112. The brush bed 112 includes a plurality of rotational brushes 134-1, 134-N. In some embodiments, the rotational brushes 134 comprise bristles. In some embodiments, the plurality of rotational brushes 134 can facilitate the application of a liquid (e.g., coating material 108) to one or more products.

The coating system 400 includes a drying station 120 further comprising a drying apparatus 122. The drying apparatus 122 can optionally include circulating gas 124 (e.g., circulating air). The drying station 120 further includes the infrared heater 140. In some embodiments, the infrared heater 140 is adjacent to a heating element. In some embodiments, the drying station 120 can be in the shape of a tunnel such that products move through the tunnel. The drying apparatus 122 includes the heating element. In some embodiments, the heating element is a convective heating element that produces convective heat 126 toward a rolling conveyor 128. In some embodiments, the drying station 120 includes one or more shields 152. The one or more shields 152 can insulate the heat generated by the heating element of the drying apparatus 122 and the infrared energy 146 from the area outside of the drying station 120.

In some embodiments, to facilitate the drying of coating material 108, the product 103 may be heated after the application of coating material 108. In some embodiments, a coating system 400 comprises a conveyor bed 136, a coating device 104 positioned above a brush bed 112 that dispenses coating material 108 toward the brush bed 112, where the brush bed 112 is configured to receive products from the conveyor bed 136; a drying apparatus 122 having a rolling conveyor 128 adjacent to the brush bed 112; and an infrared panel 144 positioned above the rolling conveyor 128 and adjacent to the drying apparatus 122, wherein the infrared panel 144 outputs infrared energy 146 toward the rolling conveyor 128.

Including infrared panels 144 toward the area of the drying station 120 where the product 103 first enters can facilitate evaporation of the water (or other solvent) that is included in the coating material 108. Infrared panels 144 facilitate rapid heating with little or no lag time to elevate a product surface temperature sufficient to promote evaporation. In some embodiments, the infrared energy 146 is precisely directed to the product 103 to facilitate rapid initiation of evaporation on the surface of the product 103. The combination of the infrared panels 144 and the convective heat 126 of the drying apparatus 122 can decrease an amount of physical space occupied by machinery, and increase efficiency of the drying process by quickly initiating evaporation of the water and/or solvent in the coating material 108, while maintaining product 103 at a sufficiently low temperature such that product 103 is not damaged.

In some embodiments, the infrared panels 144 are located a fixed distance 151 above the conveyor 130 (e.g., rolling conveyor 128), and/or a located a minimum distance 160 above a product 103. During operation, products are positioned on the translational rotational cylinders 132 and moved to the brush bed 112 where the product 103 is coated with coating material 108 dispensed from the coating device 104. The brush bed 112 moves the coated product 103 to rolling conveyor 128 and into the drying station 120. The rolling conveyor 128 positions the product 103 under the infrared panels 144 of the infrared heater 140.

In some embodiments, the infrared panel 144 is movable to adjust distance 151. For example, distance 151 can be altered according to product size, product volume, desired distance 160 between the infrared panel 144 and the product 103, and/or desired power density. The distance 151 is adjusted by moving the infrared panel 144 and/or a position of conveyor 130. In an example embodiment, the movement of the infrared panel 144 is performed manually, e.g., by an operator. Alternatively or additionally, infrared panel 144 may be automatically movable by the coating system 400 in response to a condition or command, such as to obtain or maintain a predetermined distance between conveyor 130 and/or product 103. The distances 151, 160 can be selected at least partially based on the operational power of the infrared panels 144, product type, product size, transport time under the infrared panels 144 (e.g., residence time). For example, maintaining a consistent distance from the product surface can promote treatment consistency.

In some embodiments, the distance 151 between the conveyor bed 128 and the infrared panels 144 and/or a minimum distance 160 between the product 103 and the infrared panel 144 is in a range between 1 inch and 40 inches, 5 inches to 40 inches, 10 inches to 30 inches, 15 inches to 30 inches, 20 inches to 30 inches, or about 25 inches to 30 inches. In some embodiments, the distance 151 between the conveyor bed 136 and the infrared panels, and/or a minimum distance 160 between the product 103 and the infrared panels 144 is 1 inch to 20 inches. In some example embodiments, such values can efficiently elevate a surface temperature of the product 103 to facilitate drying of the coating material 108 without damaging or permanently altering the product 103 (e.g., permanently altering the appearance, taste, moisture content, etc.). In some embodiments, a larger distance 151 or 160 can provide for increased residence time before reaching a predetermined temperature threshold for a given infrared panel 144 temperature. In some embodiments, a relatively smaller distance 151 or 160 can decrease residence time and/or more quickly increase the surface temperature of the product 103 for a given infrared panel 144 temperature.

The residence time of a product subjected to infrared energy from infrared panel 144 can be controlled to impart a predetermined energy dosage or to elevate a surface of the product 103 to a predetermined temperature. In an example embodiment, the treatment intensity (e.g., the intensity of the infrared heater 140), the distance 151 or 160, transportation speed of the conveyor 130, product 103 movement speeds, and product 103 surface area can be controlled to affect the residence time. In some embodiments, a length of time that the product 103 is between the conveyor bed 128 and the infrared panels 144 is 1 second to 200 seconds. In some embodiments, the length of time is 50 seconds, 75 seconds, 100 seconds, 150 seconds, or 200 seconds.

In various example embodiments, the product 103 is subjected to convective heating for an entire duration the product 103 is within the drying station 120. Alternatively or additionally, the product 103 is subjected to infrared energy for a shortened duration less than the duration of convective heating. For example, the duration that product 103 is subjected to infrared energy is between 5% to 90%, 10% to 90%, 20% to 80%, 25% to 75%, 30% to 60%, or about 33% of a total time within the drying apparatus 122.

In some embodiments, a reduced residence time and/or a residence time in parallel with one or more other operations of coating system 200 can promote a relatively short overall treatment time. Alternatively or additionally, a reduced residence time and/or a residence time in parallel with one or more other operations of coating system 200 can promote a relatively small physical footprint of coating system 200.

Referring now to FIG. 1E, a schematic of an example coating system 500 is shown having infrared energy application after treatment with a coating material. In an example embodiment, coating system 500 includes one or more features of example coating systems 200, 300, 400 described above with reference to FIGS. 1B, 1C, 1D. The coating system 500 includes an infrared heater 140 including a plurality of infrared panels 144, where the infrared heater 140 outputs infrared energy 146 toward rolling conveyor 128. In an example embodiment, the infrared panels 144 are implemented without convective heating (e.g., the infrared panels 144 are the only heating source).

Conveyor 130 includes conveyor bed 136 which includes a plurality of translational rotational cylinders 132-N. Alternatively or additionally, the conveyor 130 is composed of multiple sequential conveyors arranged to coordinate the transport of product 103 through the coating system 500. The translational rotational cylinders 132 move a product 103 from in the direction of the product flow 101. In some embodiments, the translational rotational cylinders 132 facilitate movement of one or more products from the conveyor bed 136 to the brush bed 112 positioned below the coating device 104.

The coating system 500 includes coating device 104. The coating device 104 includes a reservoir 106 which can be configured to contain and/or dispense coating material 108 via spray apparatus 110. The coating device 104 can be positioned above a brush bed 112. The brush bed 112 includes a plurality of rotational brushes 134-1, 134-N (which may be collectively referred to herein as rotational brushes 134). In some embodiments, the rotational brushes 134 comprise bristles. In some embodiments, the plurality of rotational brushes 134 can facilitate the application of a liquid (e.g., coating material 108) to one or more products.

The coating system 500 further comprises a drying station 120. The drying station 120 includes the infrared heater 140. In some embodiments, the drying station 120 can be in the shape of a tunnel such that products move through the tunnel.

The drying station 120 includes a first end 121 and a second end 123 having a first distance 125 therebetween. In an example embodiments, the infrared panel 144 extends the entire first distance 125 of the drying station 120 from the first end 121 to the second end 123 of the drying station 120. In some embodiments, the infrared panel 144 extends more than 25%, more than 33%, more than 50%, more than 66% more than 75% or more of the first distance 125.

In some embodiments, the infrared panels 144 are located a fixed distance 151 above the conveyor 130 (e.g., rolling conveyor 128), and/or a located a minimum distance 160 above a product 103. During operation, products are positioned on the translational rotational cylinders 132 and moved to the brush bed 112 where the product 103 is coated with coating material 108 dispensed from the coating device 104. The brush bed 112 moves the coated product 103 to rolling conveyor 128 and into the drying station 120. The rolling conveyor 128 positions the product 103 under the infrared panels 144 of the infrared heater 140.

In some embodiments, the infrared panel 144 is movable to adjust distance 151. For example, distance 151 can be altered according to product size, product volume, desired distance 160 between the infrared panel 144 and the product 103, and/or desired power density. The distance 151 is adjusted by moving the infrared panel 144 and/or a position of conveyor 130. In an example embodiment, the movement of the infrared panel 144 is performed manually, e.g., by an operator. Alternatively or additionally, infrared panel 144 may be automatically movable by the coating system 500 in response to a condition or command, such as to obtain or maintain a predetermined distance between conveyor 130 and/or product 103. The distances 151, 160 can be selected at least partially based on the operational power of the infrared panels 144, product type, product size, transport time under the infrared panels 144 (e.g., residence time). For example, maintaining a consistent distance from the product surface can promote treatment consistency.

In some embodiments, the distance 151 between the conveyor bed 136 and the infrared panels 144 and/or a minimum distance 160 between the product 103 and the infrared panel 144 is in a range between 1 inch and 40 inches, 5 inches to 40 inches, 10 inches to 30 inches, 15 inches to 30 inches, 20 inches to 30 inches, or about 25 inches to 30 inches. In some embodiments, the distance 151 between the conveyor bed 136 and the infrared panels, and/or a minimum distance 160 between the product 103 and the infrared panels 144 is 1 inch to 20 inches. In some example embodiments, such values can efficiently elevate a surface temperature of the product 103 to facilitate drying of the coating material 108 without damaging or permanently altering the product 103 (e.g., permanently altering the appearance, taste, moisture content, etc.). In some embodiments, a larger distance 151 or 160 can provide for increased residence time before reaching a predetermined temperature threshold for a given infrared panel 144 temperature. In some embodiments, a relatively smaller distance 151 or 160 can decrease residence time and/or more quickly increase the surface temperature of the product 103 for a given infrared panel 144 temperature.

The residence time of a product subjected to infrared energy from infrared panel 144 can be controlled to impart a predetermined energy dosage or to elevate a surface of the product 103 to a predetermined temperature. In an example embodiment, the treatment intensity (e.g., the intensity of the infrared heater 140), the distance 151 or 160, transportation speed of the conveyor 130, product 103 movement speeds, and product 103 surface area can be controlled to affect the residence time. In some embodiments, a length of time that the product 103 is between the conveyor bed 136 and the infrared panels 144 is 1 second to 200 seconds. In some embodiments, the length of time is 50 seconds, 75 seconds, 100 seconds, 150 seconds, or 200 seconds.

In an example embodiment, infrared energy 146 is applied to the product 103 without other heating methods (e.g., convection heat). The infrared energy 146 can facilitate precise heating of the surface of product 103, and can achieve a sufficient temperature to heat the surface of the product 103 almost instantly when activated and stop heating quickly when deactivated.

Various example systems described herein facilitate consistent and controlled heating of products using infrared energy. In an example embodiment, a method of treating a product includes (a) exposing a surface of a product to energy emitted from an infrared source that is controlled at a first predetermined elevated temperature, (b) applying a liquid (e.g., coating material 108) to the product, and (c) exposing the product to convective heat at a second elevated temperature. The product is heated with infrared energy prior to an application of a coating material. In some embodiments, prior to (a), the product is at an initial temperature that is less than the first elevated temperature.

For example, a product can be transported (e.g., shipped via train, plane, truck, boat) and arrive at an initial temperature that facilitates storage and or transportation of the product. In some embodiments, the initial temperature is a relative low temperature. Application of infrared energy prior to the application of a coating material can elevate a surface temperature of the product to a second temperature higher than the initial temperature. The second temperature facilitates even and consistent application and drying of the coating material. Imparting infrared energy at first elevated temperature can facilitate the application and drying of a solvent-based coating material. In some embodiments, the solvent is The solvent can, for example, be water, methanol, ethanol, isopropanol, butanol, acetone, ethyl acetate, chloroform, acetonitrile, tetrahydrofuran, diethyl ether, methyl tert-butyl ether, an alcohol, a combination thereof, etc. The resulting solutions, suspensions, or colloids can be suitable for forming coatings on products. For example, infrared energy rapidly heats the surface of a product such that when the coating material is applied to the product, the surface of the product is at an elevated temperature that facilitates evaporation of water-based coatings.

In some example embodiments, a method of treating a product includes (a) applying a liquid (e.g., coating material 108) to a surface of a product, (b) exposing the surface of the product to an infrared panel that is set at a first elevated temperature, and (c) exposing the product to convective heat at a second elevated temperature. The product is heated with infrared energy after an application of a coating material. Exposing the surface of the coated product to infrared energy facilitates drying of the coating material (e.g., evaporation of liquid components of the coating material) by imparting infrared energy to a product after the application of the coating material. In an example embodiment, the method includes, after exposing the product to the infrared energy, exposing the product to convective heat at a second elevated temperature. In some embodiments, the infrared energy promotes rapid initiation of evaporation such that efficient drying can be achieved by the convective heat at the second elevated temperature.

In some example embodiments, a method of treating a product includes (a) applying a liquid to a surface of a product, (b) transferring the product to a drying apparatus, (c) exposing, within the drying apparatus, the surface of the product to an infrared panel that is at a first elevated temperature, and (d) exposing, within the drying apparatus, the surface of the product to convective heat at a second elevated temperature. The product is heated with convection heat and infrared energy within the drying apparatus. In some embodiments, the method includes applying the convective heat and the infrared energy to the product simultaneously within the dryer apparatus. Alternatively or additionally, the method includes applying infrared energy to the product prior and/or after applying the convective heat within the dryer apparatus.

In some example embodiments, a method of treating a product includes infrared energy only (e.g., and not convective heat). For example, the method includes (a) applying a liquid to a surface of a product and (b) exposing the surface of the product to infrared energy at a first elevated temperature. In this embodiment, the infrared energy can be contained within a drying apparatus without convective heat.

In some embodiments, a method of applying an infrared dosage to a product includes (a) positioning a product under an infrared panel, (b) setting a distance from the product to the infrared panel, and (c) exposing a surface of the product to infrared energy at a first elevated temperature for a length of time. In some embodiments, the distance from the product to the infrared panel is 1 inch to 16 inches, the first elevated temperature is 500° F. to 1600° F., and the length of time is 1 second to 250 seconds. In some embodiments, the distance from the product to the infrared panel is 4 inches to 14 inches, the first elevated temperature is 800° F. to 1400° F., and the length of time is 125 seconds to 175 seconds. In some embodiments, the distance from the product to the infrared panel is 8 inches to 12 inches, the first elevated temperature is 1000° F. to 1200° F., and the length of time is 150 seconds to 175 seconds.

In some embodiments, the distance from the product to the infrared panel is 1 inch to 6 inches, the first elevated temperature is 1100° F. to 1200° F., and the length of time is 25 seconds to 100 seconds. Such parameters can facilitate efficient drying of the liquid coating material without overheating or adversely affecting the product (e.g. without causing internal moisture loss from the product).

In various example embodiments, treatment with a coating material on to a product results in a dried protective coating that prevents product desiccation/reduces mass loss. In some embodiments, following a treatment with a coating material on to a product, a rate of ripening of the product is reduced.

In various example embodiments, the coating material (e.g., coating material 108) includes a water-based solution. For example, the coating material includes a monoglyceride and a fatty acid salt. In some embodiments, the monoglyceride is present in the mixture in an amount of about 50% to about 99% by mass. In some embodiments, the monoglyceride is present in the coating material in an amount of about 90% to about 99% by mass. In some embodiments, the monoglyceride is present in the coating material in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the coating material in an amount of about 1% to about 50% by mass. In some embodiments, the fatty acid salt can be present in the coating material in amount of about 1% to about 10% by mass. In some embodiments, the fatty acid salt can be present in the coating material in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the coating material further comprises additives, including, but not limited to, cells, biological signaling molecules, vitamins, minerals, acids, bases, salts, pigments, aromas, enzymes, catalysts, antifungals, antimicrobials, time-released drugs, and the like, or a combinations thereof. In some embodiments, the coating material can be applied to the product in the form of a solution, suspension, or emulsion with a concentration of the coating material of about 1 g/L to about 50 g/L.

In some implementations, the coating material includes monomers, oligomers, or combinations thereof, including esters or salts formed thereof. In some implementations, the solutions/suspensions/colloids include a wetting agent or surfactant which cause the solution/suspension/colloid to better spread over the entire surface of the substrate during application, thereby improving surface coverage as well as overall performance of the resulting coating. In some implementations, the solutions/suspensions/colloids include an emulsifier which improves the solubility of the coating material in the solvent and/or allows the coating material to be suspended or dispersed in the solvent. The wetting agent and/or emulsifier can each be a component of the coating material, or can be separately added to the solution/suspension/colloid.

In various example embodiments, coatings described herein can be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by mass or by volume. In some implementations, the solvent includes a combination of water and ethanol, and can optionally be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by volume. In some implementations, the solvent or solution/suspension/colloid can be about 40% to 100% water by mass or volume, about 40% to 99% water by mass or volume, about 40% to 95% water by mass or volume, about 40% to 90% water by mass or volume, about 40% to 85% water by mass or volume, about 40% to 80% water by mass or volume, about 50% to 100% water by mass or volume, about 50% to 99% water by mass or volume, about 50% to 95% water by mass or volume, about 50% to 90% water by mass or volume, about 50% to 85% water by mass or volume, about 50% to 80% water by mass or volume, about 60% to 100% water by mass or volume, about 60% to 99% water by mass or volume, about 60% to 95% water by mass or volume, about 60% to 90% water by mass or volume, about 60% to 85% water by mass or volume, about 60% to 80% water by mass or volume, about 70% to 100% water by mass or volume, about 70% to 99% water by mass or volume, about 70% to 95% water by mass or volume, about 70% to 90% water by mass or volume, about 70% to 85% water by mass or volume, about 80% to 100% water by mass or volume, about 80% to 99% water by mass or volume, about 80% to 97% water by mass or volume, about 80% to 95% water by mass or volume, about 80% to 93% water by mass or volume, about 80% to 90% water by mass or volume, about 85% to 100% water by mass or volume, about 85% to 99% water by mass or volume, about 85% to 97% water by mass or volume, about 85% to 95% water by mass or volume, about 90% to 100% water by mass or volume, about 90% to 99% water by mass or volume, about 90% to 98% water by mass or volume, or about 90% to 97% water by mass or volume.

Coating materials formed from or containing a high percentage of long chain fatty acids and/or salts or esters thereof (e.g., having a carbon chain length of at least 14) have been found to be effective at forming protective coatings over a variety of substrates that can prevent water loss from and/or oxidation of the substrate. The addition of one or more medium chain fatty acids and/or salts or esters thereof (or other wetting agents) can further improve the performance of the coatings. The coating material 108 includes a coating material (e.g., a solute) in a solvent.

### EXAMPLES

The materials and methods of the disclosure will be further described in the following examples, which do not limit the scope of the methods and compositions of matter described in the claims.

### Example 1: Post Application, Pre Drying Apparatus—Infrared Application

The infrared panel will heat up the produce post application but before heated convective dryer to rapidly heat the coating to encourage evaporation and remove the transient period in traditional heated convective dryers, 105 avocados/test.

TABLE 1
Sequential with convective drying-normalized to no drying.

| | | | Residence | | | IR | IR | | |
|---|---|---|---|---|---|---|---|---|---|
| | Exposed | | time | Residence | Total | element | element | | Tunnel |
| | Panel | Speed | under | time in | drying | Temp | offset | | Temp |
| Test | Length | (in/s) | panel (s) | tunnel (s) | time | (F) | (in) | Air | (F) |
| 1 | 0 | 1.56 | 0 | 0 | 0 | 0 | N/A | N/A | N/A |
| 2 | 0 | 1.56 | 0 | 0 | 0 | 0 | N/A | N/A | N/A |
| 3 | 0 | 1.56 | 0 | 52.50 | 52.50 | 0 | N/A | on | 65 |
| 4 | 0 | 1.56 | 0 | 52.50 | 52.50 | 0 | N/A | on | 65 |
| 5 | 20 | 1.56 | 12.80 | 52.50 | 65.30 | 1200 | 4 | on | 65 |
| 6 | 20 | 1.56 | 12.80 | 52.50 | 65.30 | 1200 | 4 | on | 65 |
| 7 | 44 | 1.56 | 28.17 | 52.50 | 80.67 | 1200 | 4 | on | 65 |
| 8 | 44 | 1.56 | 28.17 | 52.50 | 80.67 | 1200 | 4 | on | 65 |

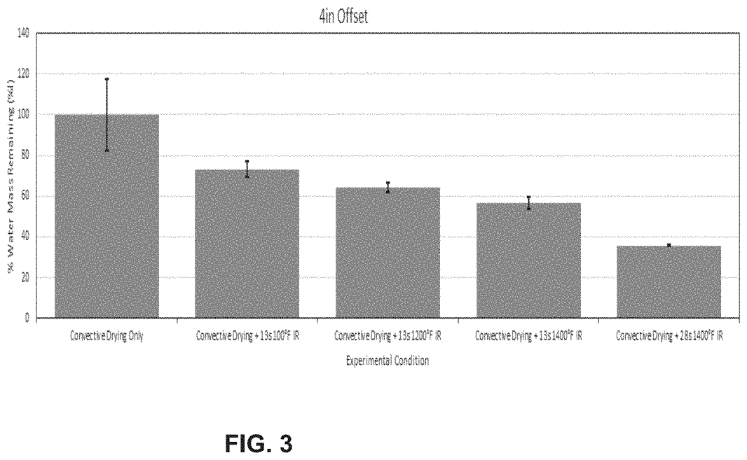

FIG. 3 depicts % water mass remaining when using a 1200° F. infrared panel, with a 4 inch offset.

TABLE 2
Effect of element temp-normalized to 40-50% convective drying. 120
avocados/test.

| | | | Residence | | | IR | IR | | |
|---|---|---|---|---|---|---|---|---|---|
| | Exposed | | time | Residence | Total | element | element | | Tunnel |
| | Panel | Speed | under | time in | drying | Temp | offset | | Temp |
| Test | Length | (in/s) | panel (s) | tunnel (s) | time | (F) | (in) | Air | (F) |
| 1 | 0 | 1.56 | 0 | 0 | 52.50 | 0 | N/A | on | 65 |
| 2 | 0 | 1.56 | 0 | 0 | 52.50 | 0 | N/A | on | 65 |
| 3 | 0 | 1.56 | 12.80 | 52.50 | 65.30 | 1000 | 4 | on | 65 |
| 4 | 0 | 1.56 | 12.80 | 52.50 | 65.30 | 1000 | 4 | on | 65 |
| 5 | 20 | 1.56 | 12.80 | 52.50 | 65.30 | 1200 | 4 | on | 65 |
| 6 | 20 | 1.56 | 12.80 | 52.50 | 65.30 | 1200 | 4 | on | 65 |
| 7 | 20 | 1.56 | 12.80 | 52.50 | 65.30 | 1400 | 4 | on | 65 |
| 8 | 20 | 1.56 | 12.80 | 52.50 | 65.30 | 1400 | 4 | on | 65 |
| 9 | 44 | 1.56 | 28.17 | 52.50 | 80.67 | 1400 | 4 | on | 65 |
| 10 | 44 | 1.56 | 28.17 | 52.50 | 80.67 | 1400 | 4 | on | 65 |

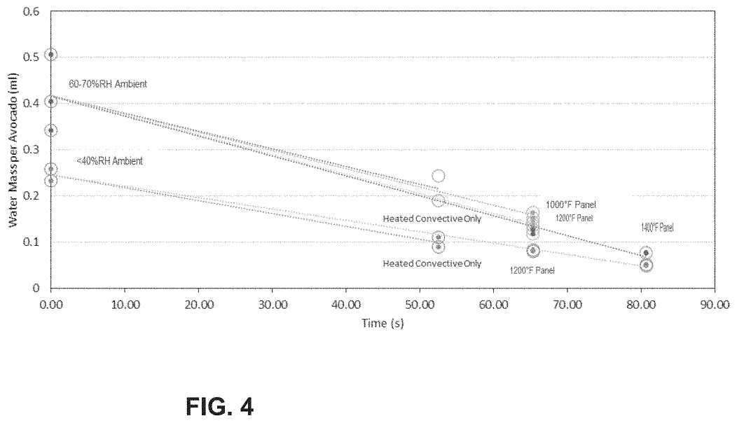

FIG. 4 depicts % solvent (e.g., water) mass remaining (% I) with different experimental drying conditions.

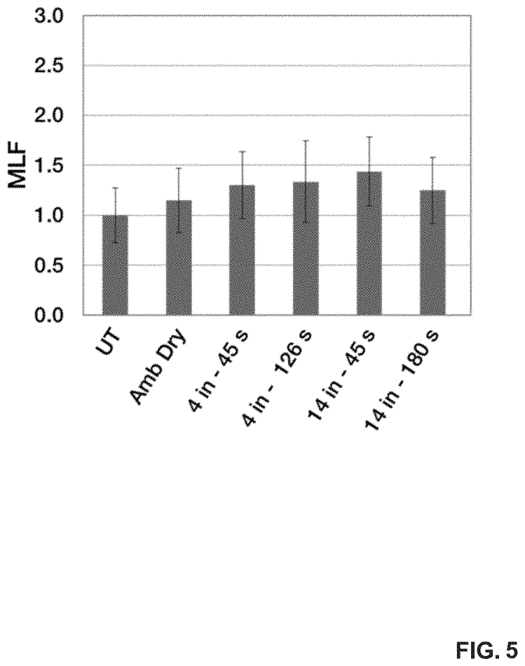

FIG. 5 depicts water mass per avocado (ml) over time in different experimental conditions.

### Example 2: Hybrid System (Infrared Panel with Conventional, Convective, or Convection Heat Inside a Drying Apparatus) and Full Infrared System (Infrared Panel(s) Without Convection Heat)

Hybrid system: the infrared panel(s) are installed with a drying apparatus which also includes a heated convection dryer.

Full infrared system: Infrared panel(s) installed in a drying apparatus without convective heat. Optionally, with the addition of convective air flow.

TABLE 3
Test matrix of avocados.

| | | | | | | Offset | Exposure |
|---|---|---|---|---|---|---|---|
| | Concentration | Number of | | | | height- | time- |
| Test | (g/L) | avocados | Treatment | Drying | Power % | inches | seconds |
| 1 | Untreated | 10 | Untreated | Ambient | N/A | N/A | N/A |
| 2 | 10 | 10 | Bowl | Ambient | N/A | N/A | N/A |
| 3 | 10 | 10 | Bowl | IR | 100 | 4 | 45 |
| 4 | 10 | 10 | Bowl | IR | 100 | 4 | 126 |
| 5 | 10 | 10 | Bowl | IR | 100 | 14 | 45 |
| 6 | 10 | 10 | Bowl | IR | 100 | 14 | 180 |

Bowl: Indicates that the avocados were dipped into the liquid coating;
IR = Infrared heat

Results: fruit exposed to IR radiation have an average mass loss factor (MLF) higher than ambient dried fruit.

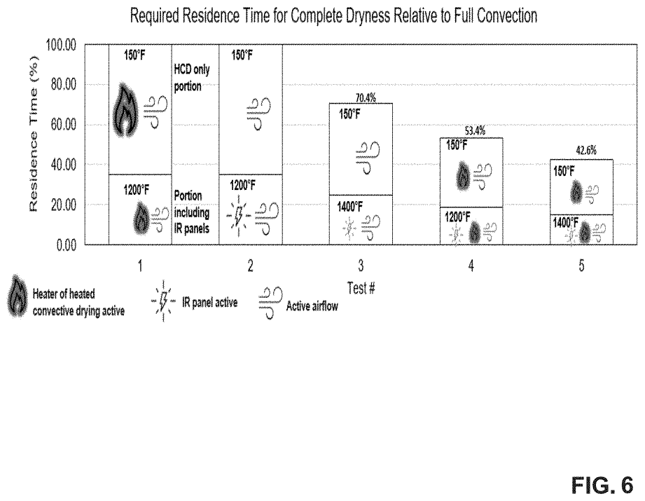

FIG. 6 depicts the mass loss factor of the avocados tested in Table 4 and Example 2.

TABLE 4
Hybrid and full Infrared system compared with heated convection
drying alone.

| | | | Residence | | IR | | IR | | |
|---|---|---|---|---|---|---|---|---|---|
| | | | time | Residence | element | Total | element | | Tunnel |
| | Dryer | Speed | under | time in | temp | Drying | offset | | Temp |
| Test | Pot | (in/s) | panel(s) | tunnel(s) | (F) | Time | (in) | Air | (F) |
| 0 | N/A | N/A | N/A | N/A | N/A | N/A | N/A | N/A | N/A |
| 1 | 0 | 0.54 | 80.82 | 150.62 | N/A | 231.45 | N/A | On | 150 |
| 2 | 0 | 0.54 | 80.82 | 150.62 | 1100- | 231.45 | 4 | On | N/A |
| | | | | | 1200 | | | | |
| 3 | 1 | 0.77 | 56.90 | 106.04 | 1400- | 162.94 | 4 | On | N/A |
| | | | | | 1500 | | | | |
| 4 | 2 | 1.01 | 43.17 | 80.46 | 1100- | 123.63 | 4 | On | 150 |
| | | | | | 1200 | | | | |
| 5 | 3 | 1.28 | 34.32 | 63.96 | 1400- | 98.28 | 4 | On | 150 |
| | | | | | 1500 | | | | |

FIG. 6 depicts measured residence time for complete dryness relative to full convection. Corresponds to the testing parameters of Table 4.

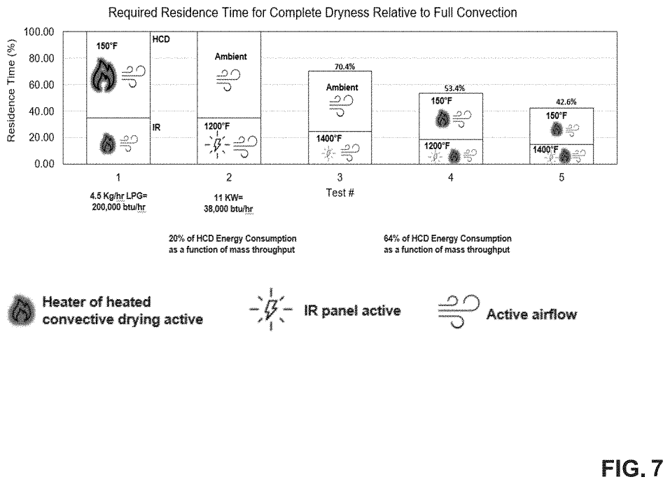

FIG. 7 depicts Energy consumption during required residence time for complete dryness relative to full convection. Corresponds to the testing parameters of Table 4.

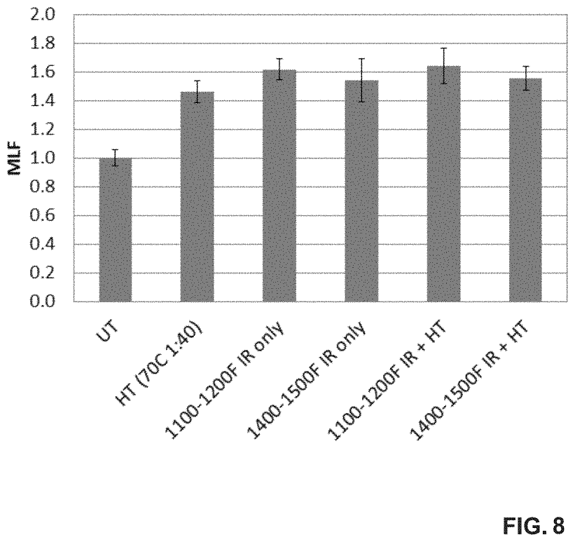

FIG. 8 depicts the mass loss factor of Hybrid and Full Infrared system compared with Heated Convection Drying alone. Corresponds to the testing parameters of Table 4.

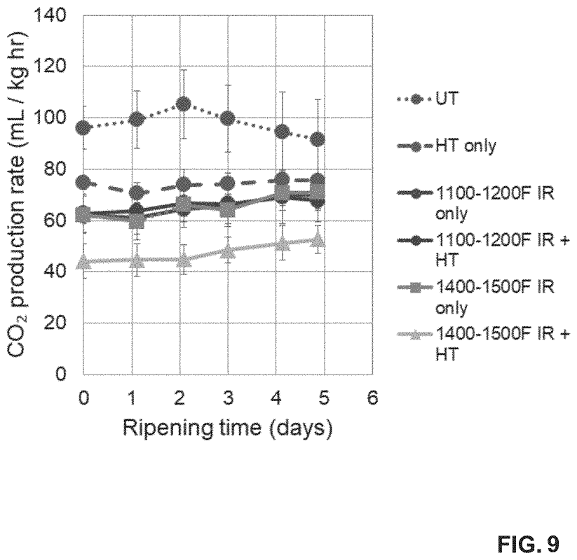

FIG. 9 depicts CO₂ production rate (ml/kg hr.) and ripening time of Hybrid and Full Infrared system compared with Heated Convection Drying alone. Corresponds to the testing parameters of Table 4.

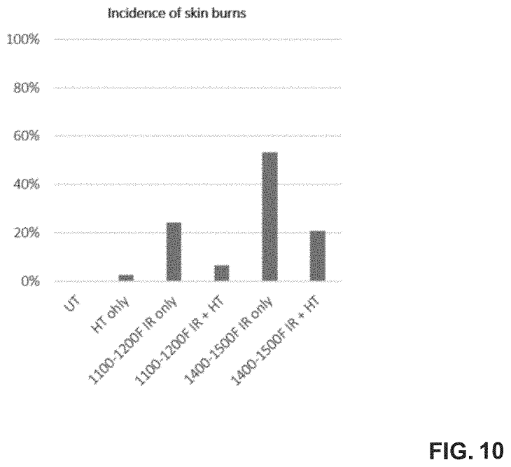

FIG. 10 depicts the incidence of skin burns to the avocados of Hybrid and Full Infrared system compared with Heated Convection Drying alone. Corresponds to the testing parameters of Table 4.

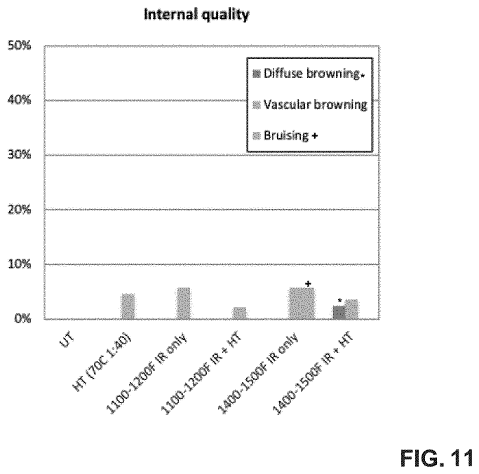

FIG. 11 depicts the internal quality of avocados of Hybrid and Full Infrared system compared with heated convection drying alone. Corresponds to the testing parameters of Table 4.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising,
a conveyor bed;
a coating device positioned above a brush bed that dispenses coating material towards the brush bed, wherein the brush bed is configured to receive products from the conveyer bed; and
an infrared panel positioned above the brush bed and downstream from the coating device, wherein the infrared panel outputs infrared energy toward the brush bed.

2. The system of claim 1, wherein a distance from the infrared panel to the brush bed is between 1 inch and 18 inches.

3. The system of claim 1, comprising a drying station that includes a rolling conveyor downstream from the brush bed.

4. The system of claim 3, comprising one or more shields positioned between the infrared panel and the drying station, wherein the one or more shields are configured to insulate the infrared panel and the drying station.

5. The system of claim 1, comprising a spray apparatus coupled to the coating device, wherein the spray apparatus is configured to disperse a liquid.

6. The system of claim 1, comprising a reservoir coupled to the coating device, wherein the reservoir is configured to contain a liquid.

7. The system of claim 1, wherein the brush bed comprises a plurality of rotational brushes.

8. A system, comprising:
a conveyor bed;
a coating device positioned above a brush bed that dispenses coating material towards the brush bed, wherein the brush bed is configured to receive products from the conveyer bed;
a drying station comprising a rolling conveyor adjacent to the brush bed; and
an infrared panel positioned above the rolling conveyor and adjacent to the drying station, wherein the infrared panel outputs infrared energy toward the rolling conveyor.

9. The system of claim 8, wherein a distance from the infrared panel to the conveyor bed is between 1 inch and 18 inches.

10. The system of claim 8, wherein the drying station comprises a first end and a second end having a first distance therebetween.

11. The system of claim 10, wherein the infrared panel extends the first distance of the drying station from the first end to the second end of the drying station.

12. The system of claim 10, wherein the infrared panel extends one-third of the first distance of the drying station.

13. The system of claim 10, wherein the infrared panel extends half of the first distance of the drying station.

14. The system of claim 10, wherein the infrared panel extends two-thirds of the first distance of the drying station.

15. The system of claim 8, comprising one or more blowers coupled to the drying station, wherein the blowers are configured to facilitate movement of gas throughout the drying station.

16. The system of claim 8, comprising a heating element coupled to the drying station, wherein the heating element is configured to heat gas to a temperature above ambient temperature.

17. The system of claim 8, wherein a radiating output of the infrared panel is from a temperature between 500° F. and 1600° F.

18. A method of treating a product, comprising:
(a) exposing a surface of a product to an infrared panel that is set at a first elevated temperature;
(b) applying a liquid to the product; and
(c) exposing the product to convective heat at a second elevated temperature.

19. The method of claim 18, wherein an initial temperature of the surface of the product is between 40° F. and 55° F.

20. The method of claim 19, wherein a distance from the product to the infrared panel is between 1 inch and 18 inches.
